(19) United States
(12) Patent Application Publication
(10) Pub. No.: US 2006/0265582 A1
(43) Pub. Date: Nov. 23, 2006

(54) METHOD FOR UPDATING FACTORY DEFAULT SETTINGS AND BOOT LOADERS IN AN EMBEDDED SYSTEM

(76) Inventors: Chao-Tsung Fan, Shenzhen (CN); Wen-Chien Chou, Shenzhen (CN); Chung-Jen Hsieh, Shenzhen (CN); Kuan-Lin Wu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,586

(22) Filed: Apr. 10, 2006

(30) Foreign Application Priority Data
May 18, 2005 (CN) 200510034717.9

(51) Int. Cl. G06F 9/00

(52) U.S. Cl. 713/2

(57) ABSTRACT

A method for updating factory default settings and boot loaders in an embedded system is disclosed. The method includes the steps of: recording factory default settings to each partition of a flash memory; installing the flash memory in the embedded system and doing function tests; generating a new boot loader comprising NVRAM variables; modifying a parameter of the NVRAM variables; and updating the new boot loader to the flash memory. The invention can be used to update boot loaders or a firmware, and generate new boot loaders based on documents modified by a user.

### FIELD OF THE INVENTION

The present invention is generally related to a method for updating factory default settings and boot loaders in an embedded system.

### DESCRIPTION OF RELATED ART

In the age of technology and information, the amount of data usage and storage has rapidly increased. This is because the Internet has provided a means for easier and more efficient data acquisition. Consequently, the need for more data storage space, more importantly, the need for secured data storage space has risen also.

To provide this additional storage space, a technology known as network attached storage (NAS) has been introduced. NAS generally refers to a data storage element or device that is connected to a network allowing access to any computers on the network, thus providing more storage space for users. A NAS device is a self-contained, intelligent storage appliance that attaches directly to a network, such as a local area network (LAN) that uses a standardized protocol such as the Ethernet or TCP/IP to share files to any host or client connected to the network.

A flash memory in a NAS board can be recorded beforehand, and the flash memory typically has some partitions for storing data. Wherein, one partition is used for storing a Contractor Furnished Equipment (CFE) boot loader, and another partition is used for storing factory default Non-Volatile Random Access Memory (NVRAM) variables. Nowadays, a flash memory can be tested by utilizing a testing program during manufacture and/or before shipment of the NAS board. The testing program is used for modifying each item of the NVRAM variables after testing the flash memory, in order to be ready for shipment; nevertheless it's easy to miss any item of the NVRAM variables. The NVRAM variable includes a name of a machine, which can be a Dynamical Host Computer Protocol (DHCP) server or a DHCP client.

Therefore, what is needed is a method for easily updating factory default settings and boot loader.

### SUMMARY OF INVENTION

A method for updating factory default settings and boot loaders in an embedded system is provided by an embodiment of the present invention. The method includes the steps of: (a) recording factory default settings to each partition of a flash memory; (b) installing the flash memory in the embedded system and doing function tests; (c) generating a new boot loader comprising Non-Volatile Random Access Memory (NVRAM) variables; (d) modifying a parameter of the NVRAM variables; and (e) updating the new boot loader to the flash memory.

Other advantages and novel features of the present invention will be drawn from the following detailed description of a preferred embodiment and preferred method with the attached drawings.

### BRIEF DESCRIPTION OF DRAWINGS

FIG. 1 is a schematic diagram of the partitions of a flash memory during manufacturing test phase;

FIG. 2 is a schematic diagram of the partitions of a flash memory during shipment;

FIG. 3 is a hardware configuration schematic diagram of an embedded system for doing function tests in accordance with one embodiment; and

FIG. 4 is a flowchart of a preferred method for updating factory default settings and boot loaders in an embedded system of FIG. 3.

### DETAILED DESCRIPTION

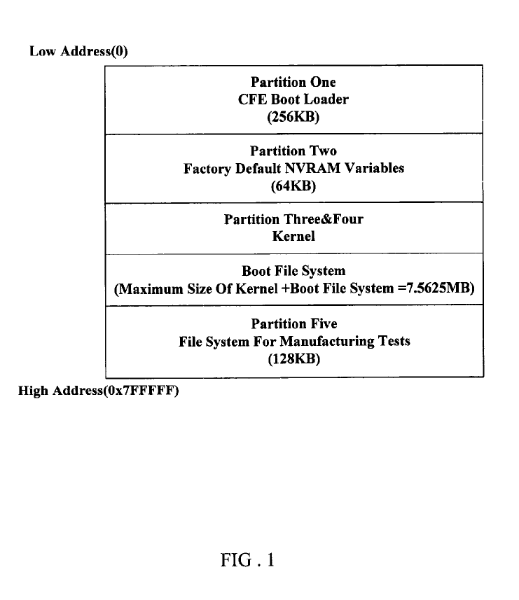

FIG. 1 is a schematic diagram of the partitions of a flash memory during a manufacturing test phase. The flash memory includes five partitions. Partition one is used for storing a Contractor Furnished Equipment (CFE) boot loader. Partition two is used for storing factory default Non-Volatile Random Access Memory (NVRAM) variables. Partition three and four are used for storing a kernel and a boot file system. Partition five is used for storing a file system for conducting manufacturing tests and is available only during the manufacturing test phase.

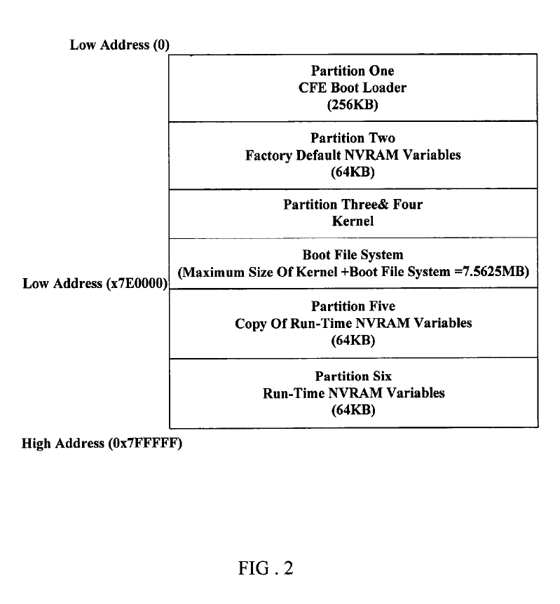

FIG. 2 is a schematic diagram of the partitions of the flash memory during shipment. Once manufacturing tests are done and the flash memory is ready to be shipped, partition five is replaced with two partitions: a new partition five that stores a copy of run-time NVRAM variables, and a partition six that stores the run-time NVRAM variables.

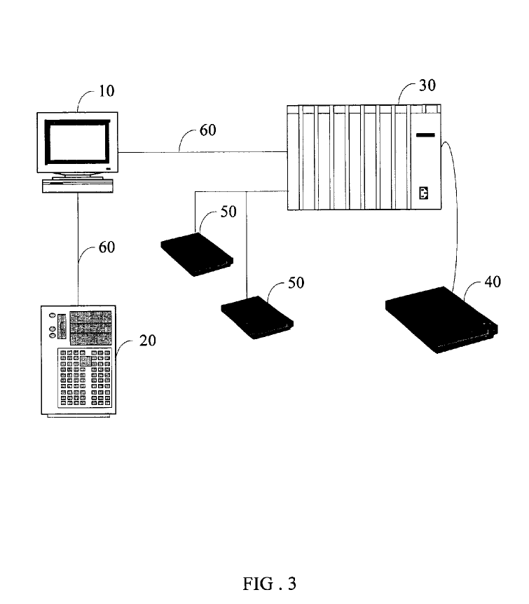

FIG. 3 is a hardware configuration schematic diagram of an embedded system for doing function tests in accordance with one preferred embodiment. In the preferred embodiment, such an embedded system is a Network Attached Storage (NAS). The hardware configuration typically includes a host computer 10, a Shop Flow Control (SFC) server 20, a Device Under Test (DUT) board 30 and a data link 60. The host computer 10 is connected with the SFC server 20 and the DUT board 30 via the data link 60. The DUT board 30 is installed with a plurality of NAS boards to be tested, and pins of the DUT board 30 are connected with testing equipments. The testing equipment can be a Hard Disk Drive (HDD) 40 or Universal Serial Bus (USB) device 50. The data link 60 can be an Unshielded Twisted Paired Local Area Network cable (UTP LAN cable).

The host computer 10 is used for obtaining information of each NAS board from the SFC server 20. The information includes Multi-Access Computer (MAC) addresses and serial numbers of the NAS boards. In other words, the SFC server 20 retrieves each serial number of the NAS boards, and then obtains corresponding MAC addresses on the basis of the serial number of each NAS board. Afterwards, the host computer 10 obtains the MAC addresses and serial numbers of the NAS boards from the SFC server 20. The host computer 10 is further used for saving test records of the function tests applied to the NAS boards. The testing equipments that are connected with the pins of the DUT board 30 include the HDD 40 and the USB devices 50. The host computer 10 stores a function test program used for testing functions of the NAS boards. The function test includes a connection test, an Integrated Device Electronics (IDE) test, a network test, a USB test, and a flash memory test. The connection test is used for testing the connection between the DUT board 30 and the host computer 10. The IDE test is used for testing the number of the HDD 40 that is connected with the DUT board 30. The IDE test is further used for testing the interface types of the HDD 40. Interface types include an IDE interface and a Small Computer Systems Interface (SCSI). The network test is used for testing whether the HDD 40 can receive parameters. These parameters include MAC addresses of the host computer 10 and the number of information packages. The USB test is used for testing the number of the USB devices 50 that are connected with the DUT board 30. The USB test is further used for testing types of the USB devices 50. The flash memory test is used for testing the marking number of the flash memory and the capacity of the flash memory.

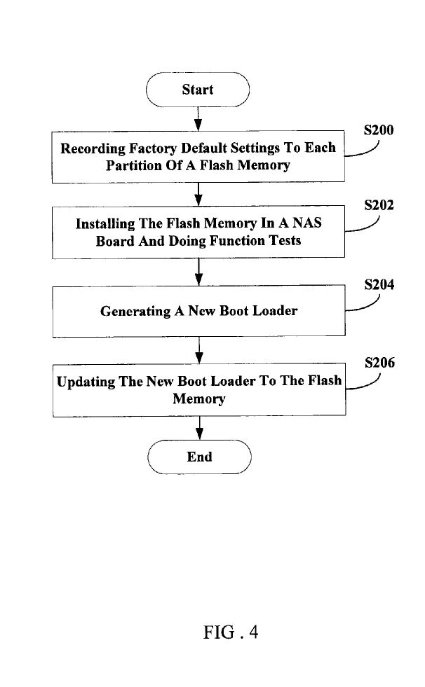

FIG. 4 is a flowchart of a preferred method for updating factory default settings and boot loaders in the embedded system of FIG. 3. The method is described in associating with FIG. 1 and FIG. 2. In step S200, factory default settings are recorded to each partition of the flash memory at a machining workstation. The machining workstation, which is in front of a Surface Mounting Technology workstation (SMT workstation), is a workstation for recording the flash memory. The partitions of the flash memory are described in FIG. 1. The values of the factory default NVRAM variables are as follows: cfe_configuration_state=initialized; manufacturing_state=tested_ok; et0macddr=MAC address (fixed value); board num=serial number (fixed value).

The “MAC address” and the “serial number” are fixed values. For the convenience of the tests, all “serial numbers” of the NAS boards are the same as the values of corresponding “MAC addresses”. The NAS boards are installed in the DUT board 30. In step S202, the recorded flash memories are installed in the NAS board at the SMT workstation. The function test program stored in the host computer 10 tests functions of the NAS boards. This function test includes a connection test, an IDE test, a network test, a USB test, and a flash memory test. In step S204, the function test program generates a new boot loader according to a boot loader modified by a user after the NAS board passes the function test, the value of the NVRAM variable “cfe_configuration_state=initialized” is modified to “cfe_configuration_state=not_initialized,” and the NAS waits for the new boot loader to be updated in the flash memory. The new boot loader has correct serial numbers of the NAS boards, the corresponding MAC addresses, and other NVRAM variables that are decided by a user. The NVRAM variables include a name of a machine, which can be a Dynamical Host Computer Protocol (DHCP) server or a DHCP client. In step S206, the new boot loader is updated in each partition of the flash memory on the NAS board and the values of the NVRAM variables in the new boot loader are ready for shipment. The values of the NVRAM variables are as follows: cfe_configuration_state=initialized; manufacturing_state=tested_ok; et0macddr=MAC address (unattached value); board num=serial number (unattached value).

NVRAM is a type of computer memory chip that does not lose its information when the power is turned off. NVRAM is commonly used in computer systems, routers, and other electronic devices to store settings that must survive a power cycle (like number of disks and memory configuration).

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A method for updating factory default settings and boot loaders in an embedded system, the method comprising the steps of:
recording factory default settings to each partition of a flash memory;
installing the flash memory in the embedded system and doing function tests;
generating a new boot loader comprising NVRAM variables;
modifying a parameter of the NVRAM variables;
updating the new boot loader to the flash memory.

2. The method according to claim 1, wherein the embedded system is a NAS.

3. The method according to claim 2, wherein the new boot loader further comprising correct serial numbers of the NAS boards and corresponding MAC addresses.

4. The method according to claim 3, wherein the serial numbers of the NAS boards and the MAC addresses are fixed values.

5. The method according to claim 1, wherein the NVRAM variables include a name of a machine.

6. The method according to claim 1, wherein the parameter in the step of modifying a parameter of an NVRAM is: cfe_configuration_state=not_initialized.
